(19) United States
(12) Patent Application Publication
(10) Pub. No.: US 2026/0356357 A1
(43) Pub. Date: Nov. 12, 2026

(54) VEHICLE CONTROL APPARATUS PERFORMING TRAVELING SUPPORT AND PROGRAM THEREOF

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventor: Naoki ICHIHARA, Tokyo (JP)

(21) Appl. No.: 19/461,303

(22) Filed: Jan. 27, 2026

(30) Foreign Application Priority Data
Jan. 29, 2025 (JP) 2025-012844

(51) Int. Cl. B60W 30/12; B60W 10/20; G06V 20/56

(52) U.S. Cl. CPC B60W 30/12; B60W 10/20; G06V 20/588; B60W 2420/403; B60W 2520/10; B60W 2540/18; B60W 2552/30; B60W 2552/53; B60W 2556/20

(57) ABSTRACT

A vehicle control apparatus is provided to execute a steering angle control for controlling a steering angle of the vehicle to prevent the vehicle from deviating outside a reference boundary line, including a first steering angle control unit that controls an orientation of the vehicle to be oriented away from the reference boundary line in a lateral direction of the road, and while maintaining the vehicle orientation, controls the steering angle to cause a lateral acceleration of the vehicle with respect to the reference boundary line to be 0; and a second steering angle control unit that terminates, when the steering angle of the vehicle is controlled by the first steering control unit to be a steering angle causing the lateral acceleration to be 0, the steering angle control at a time when a predetermined period elapses maintaining the controlled steering angle corresponding to the lateral acceleration of 0.

### CROSS-REFERENCE OF RELATED APPLICATIONS

The present application is based on and claims the benefit of priority from earlier Japanese Patent Application No. 2025-12844 filed on Jan. 29, 2025, the content of which is incorporated herein by reference.

### BACKGROUND

### Technical Field

The present disclosure relates to a vehicle control apparatus that performs a traveling support of a vehicle and a program thereof.

### Description of the Related Art

As a traveling support control, a technique is known for controlling a vehicle to return to a center of a traveling lane using a steering control of the vehicle so as to avoid lane deviation of the vehicle in the case where a vehicle travelling on the traveling lane excessively approaches either a left lane marking or a right lane marking. Such a technique is generally referred to as a lane deviation suppression function. Specifically, according to the lane deviation suppression function, when the vehicle approaches a reference boundary line of a road within a predetermined distance, the steering angle of the vehicle is controlled such that the vehicle does not deviate outside the reference boundary line.

### SUMMARY

The vehicle control apparatus according to the present disclosure is configured to execute, for a vehicle traveling on a road, a steering angle control for controlling a steering angle of the vehicle to prevent the vehicle from deviating outside a reference boundary line, when the vehicle approaches the reference boundary line within a predetermined distance, the reference boundary line being either a road boundary as road ends of left and right sides of a road or left-right markings on a traveling lane in the road.

The vehicle control apparatus includes: a first steering angle control unit that controls, when activating the steering angle control, an orientation of the vehicle to be oriented away from the reference boundary line in a lateral direction of the road using a steering operation for lane-departure avoidance side, and while maintaining the vehicle orientation, controls the steering angle of the vehicle to cause a lateral acceleration of the vehicle with respect to the reference boundary line to be 0; and a second steering angle control unit that terminates, when the steering angle of the vehicle is controlled by the first steering control unit to be a steering angle causing the lateral acceleration to be 0, the steering angle control at a time when a predetermined period elapses maintaining the controlled steering angle corresponding to the lateral acceleration of 0.

### BRIEF DESCRIPTION OF THE DRAWINGS

In the accompanying drawings:

FIG. 1 is a block diagram showing a configuration of a traveling support system of a vehicle;

FIG. 2 is a plan view of a road showing a traveling scene in which a vehicle is likely to depart from a lane;

FIG. 3 is a timing diagram showing a series of steering angle control;

FIG. 4 is a graph showing a relationship between a vehicle angle and a predetermined time TA;

FIG. 5 is a graph showing a relationship between a vehicle angle and a predetermined time TA;

FIG. 6 is a graph showing a relationship between a lane width and a predetermined time TA;

FIG. 7 is a flowchart showing a procedure of a lane departure mitigation control;

FIG. 8A is a diagram showing traveling scene of a curved road;

FIG. 8B is a diagram showing traveling scene of a curved road;

FIG. 9 is a flowchart showing a process for setting a predetermined time TA;

FIG. 10 is a graph showing a relationship between a traveling speed and a lateral distance target value or a target angle value;

FIG. 11 is a graph showing a relationship between a lane width and a lateral distance target value or a target angle value;

FIG. 12 is a flowchart showing a procedure of a lane departure mitigation control; and

FIG. 13 is a flowchart showing a procedure of a lane departure mitigation control according to a second embodiment.

### DETAILED DESCRIPTION OF THE PREFERRED EMBODIMENTS

As a traveling support control, for example, JP-A-2018-79835 discloses a technique for controlling a vehicle to return to a center of a traveling lane using steering angle control of the vehicle so as to avoid lane deviation by the vehicle in the case where a vehicle travelling on the traveling lane excessively approaches either a left lane marking or a right lane marking. Such a technique is generally referred to as a lane deviation suppression function. Specifically, according to the lane deviation suppression function, when the vehicle approaches a reference boundary line of a vehicle within a predetermined distance, the steering angle of the vehicle is controlled such that the vehicle does not depart outside the reference boundary line.

In the case where a steering angle control of a vehicle is performed to avoid a lane deviation when the vehicle deviates to either lane (e.g. right side lane) of the traveling lane, firstly, an automatic steering control is performed for a left turn to cause the vehicle to recede from the right side lane. Further, after performing the steering control of the left turn, a reverse steering control (e.g. right-turn steering) is performed to vehicle to be parallel to the left and right lane markings. In this case, due to the reverse steering, the orientation of the vehicle varies depending on at each occasion, and may cause a sense of incongruity to a driver. For example, although the vehicle has a lane marking recognition function that recognizes lane marking with an image captured by a camera, when the lane marking cannot be visually recognized due to deterioration or dirt, the reverse steering control cannot be appropriately performed, causing a variation in the orientation of the vehicle. Hence, there is a concern that incongruity is given to the driver.

Hereinafter, with reference to the drawings, embodiments in which a vehicle control apparatus according to the present disclosure is embodied will be described. According to the present embodiment, a traveling support system performing a vehicle traveling support for passenger cars, trucks, buses and the like.

### First Embodiment

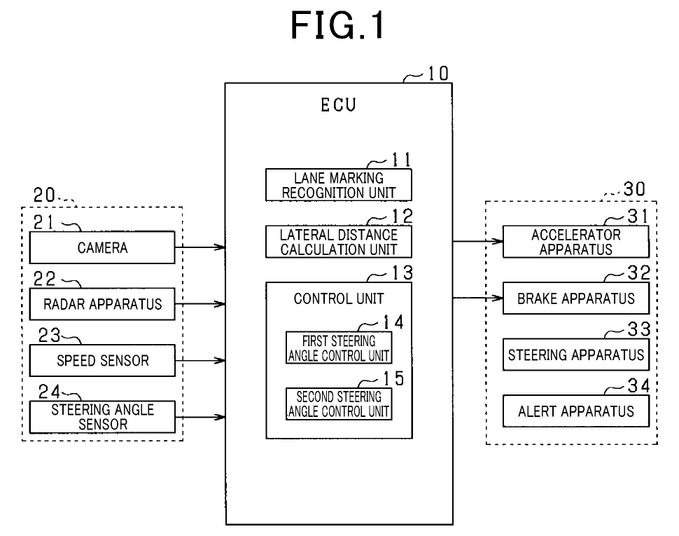

As shown in FIG. 1, a traveling support system according to the present embodiment is provided with an ECU (electronic control unit) as a vehicle control apparatus, sensors 20 and a control object apparatus 30. The sensors 20 include a camera 21, a radar apparatus 22, a speed sensor 23 and a steering angle sensor 24. The camera 21 and the radar apparatus 22 correspond to an object detection apparatus that detects object existing around the vehicle. The control object apparatus 30 includes an accelerator apparatus 31, a brake apparatus 32, a steering apparatus 33 and an alert apparatus 34.

The camera 21 is configured as, for example, a single-camera. For example, the camera 21 is configured of a plurality of imaging apparatuses capable of capturing images in a front side, a rear side and lateral right and left side of the vehicle. With these respective cameras 21, images in the vicinity of the vehicle are captured. The camera that captures an image in the front side of the vehicle is disposed in a vicinity of a front bumper or an upper part of the wind shield of the vehicle. The respective cameras 21 transmit captured images to the ECU 10 at a predetermined interval. Note that the camera 21 may be configured as a stereo camera.

The radar apparatus 22 is a ranging apparatus of which the transmission waves are millimeter wave band high frequency signal. The radar apparatus 22 is mounted to, for example, a front end part, a rear end part, lateral left and right side surfaces of the vehicle, measuring a distance to objects in the vicinity of the vehicle. Specifically, the radar apparatus 22 transmits probing waves at a predetermined period and receives reflected waves using a plurality of antennas, thereby measuring a distance to objects using a transmission time of the probing waves and a reception time of the reflected waves. Further, the radar apparatus 22 utilizes phase difference of the reflected waves received by a plurality of antennas, thereby calculating azimuths of the objects. The distances to the objects and azimuths of the objects are calculated. As a result, relative locations of the objects with respect to the vehicle can be identified.

The speed sensor 23 detects a traveling speed of the vehicle. For example, as the speed sensor 23, a wheel speed sensor that detects rotation speed of the wheels can be used. The steering angle sensor 24 detects a steering angle of a steering member of the vehicle.

The accelerator apparatus 31 is an engine or a motor as a driving source of the vehicle. When the driver operates an acceleration unit, the ECU 10 transmits a control command to drive the accelerator apparatus 31, thereby applying a driving force to the vehicle for traveling. The brake apparatus 32 is mounted to each wheel of the vehicle. In the braking operation of the driver, the brake apparatus 32 is activated by a control command transmitted by the ECU 10, and the braking force is applied to the vehicle.

The steering apparatus 33 serves as a motor for a steering operation of the vehicle. For example, when the driver performs a turning operation, the steering apparatus 33 is activated in response to a control command transmitted from the ECU 10, and the vehicle is caused to turn. The alert apparatus 34 is a display apparatus capable of displaying an alert or a speaker capable of outputting a sound as a notification of an alert. The alert apparatus 34 notifies the driver of a state of vehicle or vehicle-surroundings or a state where a travelling-safety of the vehicle is impaired.

The ECU 10 is an electronic control apparatus provided with a known microcomputer composed of CPU as a processor, ROM, RAM, flash memory unit and the like. The microcomputer provides various calculation functions. The functions provided by the microcomputer can be provided by software stored in a substantial memory device and a computer that executes the stored software, only the software, only a hardware or a combination thereof. The microcomputer executes a program stored in a non-transitory tangible storage medium as a memory unit included therein. The program includes routines corresponding to an object recognition process for recognizing object around the vehicle, a process for a collision avoidance or a damage mitigating of a collision, and a process for controlling a traveling speed of the vehicle. With an execution of the program, methods corresponding to the program are executed. The memory unit is, for example, a non-volatile memory. Note that programs stored in the memory unit can be updated via a network such as internet, for example.

The ECU 10 acquires object detection information from each of the camera 21 and the radar apparatus 22, and recognizes objects existing around the vehicle based on the acquired information. Specifically, a relative location and an existing region of the objects as image information are calculated in accordance with a distance to the objects and an azimuth of the objects calculated from the camera image, and a relative location and an existing region of the objects as radar information are calculated in accordance with a distance to the objects and an azimuth of the objects included in the distance information acquired from the radar apparatus 22. Then, these image information and the radar information are merged (fusion process) to recognize objects. At this moment, objects are recognized based on an overlapped region between the existing region of objects included in the image information and the existing region of objects included in the radar information. However, according to the present embodiment, any methods of object recondition can be utilized, for example, objects can be recognized based on only object detection information of the camera 21 in the object detection information of the camera 21 and the radar apparatus 22, or only object detection information of the radar apparatus 22.

The ECU 10 executes, as a traveling support control of the vehicle, a collision mitigation control (i.e. PCS: pre-crash safety) or a lane departure mitigation control (i.e. LDA: lane departure alert). Specifically, as the collision mitigation control, the ECU 10 calculates, based on the relative distance and relation speed between the vehicle and the object, a collision prediction time (i.e. TTC: time to collision) as a time to collision between the vehicle and the object, and executes a collision avoidance control for avoiding a collision using a comparison between the collision prediction time and an operation timing. At this moment, the ECU 10 utilizes the brake apparatus 32 included in the control object apparatus 30 to brake the vehicle, thereby avoiding a collision with the object. Also, an automatic steering operation of the vehicle may be performed using the steering apparatus 33 to avoid collision between the vehicle and the object. Alternatively, the alert apparatus 34 may be used to notify the driver of risk of collision. Note that the operation timing is a required timing for activating the control object apparatus 30 and the like, and may be set depending on objects to be activated.

Also, the ECU 10 executes, when the vehicle is likely to depart from the traveling lane (own lane), a turning control of the vehicle using the steering apparatus 33 to suppress the lane departure as a lane departure mitigation control. In this case, the ECU 10 determines a lane marking as a left-right white marking or the like in the traveling lane to be a reference boundary line, and prevents the vehicle from deviating outside the reference boundary line (outside traffic lane) based on the reference boundary line and the vehicle location. As the lane departure mitigation control, in addition to a lane departure mitigation control to mitigate a lane departure using the turning control of the steering apparatus 30, the alert apparatus 34 may output an alert to the driver to prevent the vehicle from deviating from the traffic lane as the lane departure mitigation control.

In the lane departure mitigation control, instead of determining the left-right side markings of the traffic lane to be the reference boundary line, road boundaries as the road ends of left and right sides of the road may be determined as the reference boundary lines. A road end is, for example, a curb stone or a pavement boundary position. In this case, the ECU 10 recognizes road ends in the left and right sides of the road and executes the lane departure mitigation control such that the vehicle does not deviate outside the road ends in the left and right sides of the road. In the lane departure mitigation control, either one reference boundary line between left side or right side of the road may be determined as the lane marking, and the other reference boundary line may be determined as the road end.

In the case where the vehicle deviates in the left side or the right side of the road and approaches the lane marking (e.g. white line) within a predetermined distance, the steering angle of the vehicle is controlled as a steering control to prevent the vehicle from deviating outside the reference boundary line. At this moment, in the case where the vehicle moves away from the reference boundary line and then a reverse steering control is performed, the orientation of the vehicle is likely to vary at a time when completing the steering control, and may cause an incongruity sense of a driver.

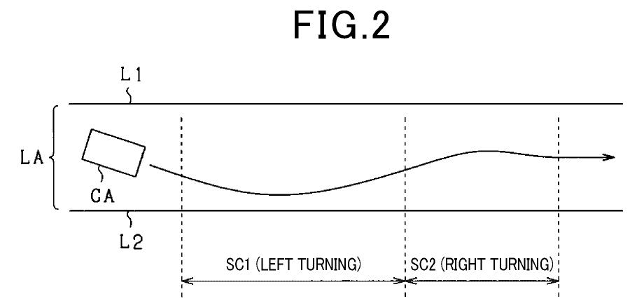

For example, in a traveling scene of the vehicle CA shown in FIG. 2, the driver performs a manual steering and causes the vehicle CA to be traveling on the traveling lane LA (own lane) on the road. The lane markings L1 and L2 such as a white marking or a yellow marking are present on the left and right side of the traveling lane LA. In this traveling scene, when the vehicle CA approaches the right side lane marking L2 and the lateral distance D1 between the right end part of vehicle CA and the lane marking L2 is shorter than a predetermined threshold TH, the steering apparatus 33 starts to perform the steering angle control as the lane departure mitigation control. After starting the steering angle control, a left-turn steering is performed in a direction orthogonal to the direction along the traveling lane LA for causing the vehicle CA to move away from the lane marking L2. Then, the vehicle CA gradually moves away from the lane marking L2. Further, when the vehicle CA returns to a portion in a vicinity of the center of the traffic lane, a reverse steering (right-turn steering) is performed such that the traveling direction of the vehicle CA is parallel to the lane marking L1 and L2, and the steering angle control is terminated.

According to a known control in the above-described traveling scene, firstly in a section SC1, left-turn steering is performed by the steering angle control, then right-turn steering as reverse steering is performed in the section SC2. In this case, when the orientation of the vehicle CA varies at a time when the steering angle control is completed, it may cause an incongruity sense of a driver of the vehicle CA. For example, in the case where the vehicle CA is not able to visually recognize the lane marking due to deterioration or dirt, reverse steering cannot be appropriately performed and the orientation of the vehicle CA may vary.

Note that the lateral distance D1 is a distance between a part of the vehicle CA which is the closest to the lane markings L1 and L2, and the lane markings L1 and L2. However, the lateral distance D1 may be a distance between a center part of the front wheels in the front side of the vehicle CA and the lane markings L1 and L2. The reference location of the lane markings L1 and L2 may be an edge part inside the traffic lane or outside the traffic lane, or a center location of the lane markings L1 and L2 in the width direction.

In this respect, according to the present embodiment, when activating the steering angle control for the lane departure mitigation, a first steering angle control is executed to control the orientation of the vehicle CA to be oriented away from the reference boundary line in the lateral direction of the road using the steering operation for lane-departure avoidance side, and while maintaining the vehicle orientation, control the steering angle of the vehicle CA to cause the lateral acceleration of the vehicle CA with respect to the reference boundary line to be 0. Also, the second steering angle control is executed in the following manner. After the first steering angle control controls the steering angle CA to cause the lateral acceleration with respect to the reference boundary line to be 0, the controlled steering angle is maintained for a predetermined period, and then the steering angle control is terminated. Hereinafter, the above-described control will be described in detail. In the following description, the ECU 10 is configured to recognize the left and right lane markings (white line and the like) of the traveling lane as the reference boundary line, and execute the lane departure mitigation control based on the recognized lane markings.

As shown in FIG. 1, the ECU 10 is provided with, as a configuration related to the lane departure mitigation control, a lane marking recognition unit 11, a lateral distance calculation unit 12 and a control unit 13. The control unit 13 is provided with a first steering angle control unit 14, a second steering angle control unit 15

The lane marking recognition unit 11 recognizes left and right lane markings L1 and L2 on the traveling lane of the vehicle CA. At this moment, captured image of the camera 21 may be utilized to recognize the lane markings L1 and L2 based on a change in the luminance in the captured image. Specifically, the ECU 10 extracts, as edge points, points where contrast (illuminance)on the road surface is changed for the lane markings such as a white line that divides the traffic lane on the road surface. Then, the ECU 10 recognizes lane markings in accordance with a row of edge points where the extracted edge points are connected.

The lateral distance calculation unit 12 calculates a lateral distance D1 between an end portion in either left side or right side of the vehicle CA and the lane markings L1 and L2 on the traveling lane.

The control unit 13 compares the lateral distance D1 calculated by the lateral distance calculation unit 12 with the threshold TH. When the lateral distance D1 is shorter than the threshold TH, the steering apparatus is utilized to execute a steering control to control the steering angle CA such that the vehicle CA does not deviate outside the lane marking.

As a detailed configuration of the steering control, the first steering angle control unit 14 is configured to, when activating the steering angle control, change a steering angle in a direction to avoid the deviation so as to change the orientation of the vehicle CA to be along a direction away from the lane marking from which the vehicle CA is deviating, and control the steering angle of the vehicle CA with current vehicle orientation such that the lateral acceleration of the vehicle CA with respect to the lane marking is 0 (first steering angle control). Further, the second steering control unit 15 is configured to, when the steering angle of the vehicle CA is controlled to be a steering angle causing the lateral acceleration to be 0 with respect to the lane marking by the first steering angle control unit 14, terminate the steering angle control at a time when the controlled steering angle has maintained for a predetermined period (second steering angle control).

The first steering angle control serves as an avoidance control for executing a lane-departure avoidance of the vehicle CA in a first part of the steering angle control. Further, the second steering angle control serves as a resume control executed in a second part of the steering angle control for appropriately resuming the state of the vehicle CA to be in a driver manual steering after executing the lane-departure avoidance.

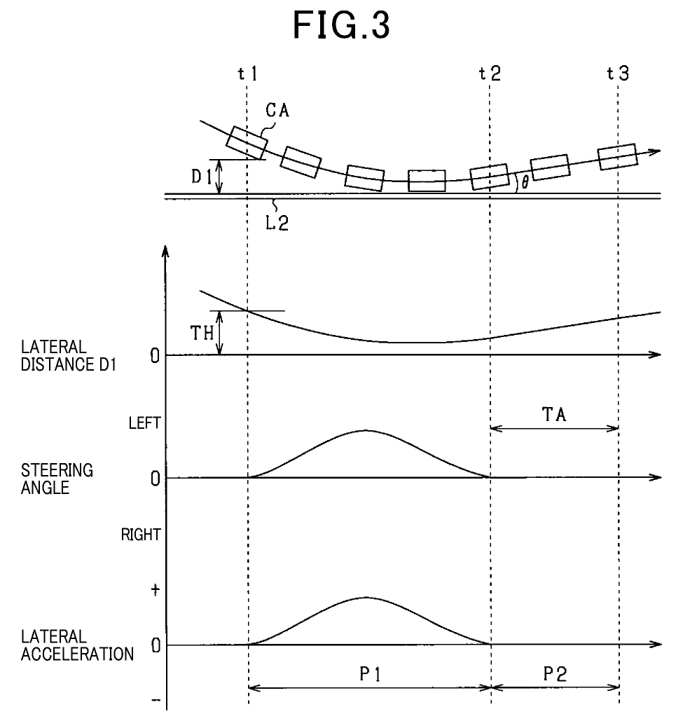

FIG. 3 is a timing diagram showing a series of steering angle control according to the present embodiment. In this case, a traveling scene where the vehicle CA travels on a straight road will be described. FIG. 3 shows a change in the orientation of the vehicle CA on the traveling lane LA, where a distance to a lane marking L2 positioned at a right side traffic lane is defined as a lateral distance D1. The steering angle indicates a left and right side steering angle in which the steering angle of the vehicle CA traveling straight is defined as zero. In the vehicle CA, an acceleration in the lateral direction produced with respect to the lane markings L1 and L2, that is, an acceleration produced in a direction orthogonal to the lane markings L1 and L2 is defined as the lateral acceleration. In the case where the vehicle CA travels on a straight road, a change in the steering angle and a change in the lateral acceleration are substantially the same. Note that the lateral acceleration is a difference value (change rate with respect to time) of the vehicle speed in a direction orthogonal to the lane marking L1 and L2.

In FIG. 3, prior to time t1, the vehicle CA is traveling on the traveling lane LA with a manual steering of the driver. The steering angle prior to time t1 is 0. Also, a case is assumed that a steering angle is produced in a right turning direction prior to time t1.

At time t1, when the distance D1 between the vehicle CA and the lane marking L2 is shorter than the threshold TH, the steering angle control of the steering apparatus 33 is activated. A period from time t1 to time t2 is a first period P1 where the first steering angle control is performed. In the first period P1, the steering operation is performed in a lane-departure avoidance side (left-turn steering according to the present embodiment). Thus, the orientation of the vehicle CA becomes along a direction away from the right lane marking, and the lateral distance D1 is changed to be in an increase side from a decrease side. The time at which the lateral distance D1 becomes minimum is a time at which the yaw angle of the vehicle CA becomes 0 degree.

In the first period P1, the steering angle in the left-turn side gradually increases and then gradually decreases. With this change, the lateral acceleration of the vehicle CA gradually increases and then gradually decreases. Thereafter, at time t2, the steering angle becomes 0 in a state where the orientation of the vehicle CA becomes along a direction away from the right lane marking. Further, at time t2, the lateral acceleration of the vehicle CA becomes 0. In this state, the vehicle CA is in a straight traveling in which the vehicle is oriented inside the lane and has 0 steering angle (lateral acceleration is 0).

In the first period P1, a target trajectory where the vehicle CA travels is determined and the steering angle is controlled so as to cause the vehicle CA to travel on the target trajectory. In this case, the target trajectory may be determined based on the traveling speed of the vehicle CA or an angle of the traveling direction inclined with respect to the lane marking.

Moreover, a target value of the lateral distance D1 at an end timing (time t2) of the first steering control may be determined in advance, and the first steering control may be terminated at a time at which the lateral distance D1 of the vehicle CA reaches the target value. Moreover, a target value of a vehicle angle θ, as an angle of a traveling direction of the vehicle CA inclined with respect to the lane marking of the traveling lane at an end timing (time t2) of the first steering control, may be determined in advance, and the first steering control may be terminated at a time at which the vehicle angle θ reaches the target value. Note that the vehicle angle θ can be also interpreted as a lateral speed of the vehicle CA with respect to the lane marking of the traveling lane.

A period from time t2 to t3 is defined as a second period P2 in which the second steering angle control is performed. During the second period P2, the steering angle of the vehicle CA is maintained to be 0 from a time t2 to a time when a predetermined period TA elapses. Then, the steering angle control is terminated at a time t3 at which a predetermined period TA elapses. After terminating the steering control, the steering operation of the vehicle CA is changed from an automatic steering to a manual steering by the driver. During the second period P2, the drive recognizes a state where the orientation of the vehicle CA is set for straight traveling of the vehicle CA, and an operation subject (operator) of the vehicle CA is resumed to the driver at a time t3. During the second period P2, the steering control may be terminated before the vehicle CA reaches a center position of the traveling lane in the lateral direction.

The predetermined period TA may be set in advance as a period having a certain value. The predetermined period TA is, for example, a period in which the vehicle CA travels for several meters to 10 meters. However, the predetermined period TA may be set as a variable period. Note that a detailed description of the variable period will be described later.

According to the above-described control, since the steering control is terminated with a state of the steering angle being 0, the orientation of the vehicle CA does not vary at a time when the steering control is terminated. Hence, it can be prevented from causing a sense of incongruity to a driver of the vehicle CA.

According to the second steering angle control, the steering angle control is terminated at a time when the predetermined period TA elapses with a state of the steering angle being 0. In this case, the orientation of the vehicle CA within the traveling lane is not parallel to the lane markings L1 and L2. Hence, when the second steering control takes an excessively long time, after the lane departure mitigation for the right-side lane marking L1 is performed, the vehicle may excessively approach the opposite lane marking (i.e. left-side lane marking). Taking this into consideration, the predetermined period TA may be variably set based on a state parameter of the vehicle CA at a time when the steering angle CA becomes 0.

The control unit 13 acquires a state parameter showing a traveling state of the vehicle CA at a time when the steering angle of the vehicle CA becomes 0 by the first steering angle control (time t2 in FIG. 3) (corresponding to parameter acquiring unit), and sets the predetermined period TA to be variable based on the state parameter. The state where the steering angle of the vehicle CA becomes 0 refers to a state where the vehicle CA travels obliquely within the traveling lane.

For example, the control unit 13 acquires, as the state parameter, either a lateral distance D1 from the lane marking of the traveling lane to the vehicle CA at a state of the steering angle being 0 or a vehicle angle θ (see FIG. 3) as an angle of the traveling direction of the vehicle CA inclined with respect to the lane marking of the traveling lane, and sets the predetermined period TA to be variable based on the acquired lateral distance D1 or the vehicle angle θ. The vehicle angle θ may be calculated based on an image captured by the camera 21 for example. In this case, the vehicle angle θ may be calculated based on an extending direction of the lane marking recognized from the captured image.

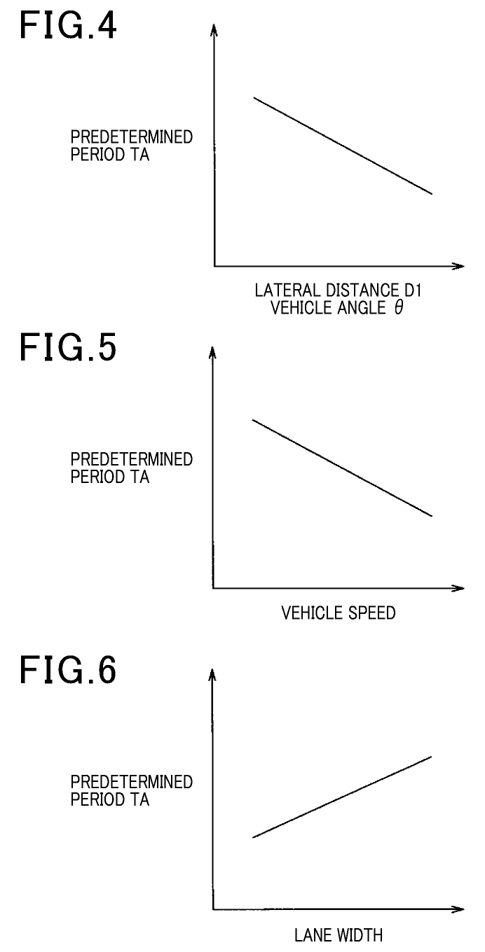

In a state where the steering angle of the vehicle CA is 0, the longer the lateral distance D1 from the lane marking as an object with which a lane departure is avoided to the vehicle CA, the higher the probability of the vehicle CA excessively approaching the opposite side lane marking is, after the steering operation is changed to the manual steering operation from the automatic steering operation. Moreover, the larger the vehicle angle θ, the higher the probability of the vehicle CA excessively approaching the opposite side lane marking is, after the steering operation is changed to the manual steering operation from the automatic steering operation. In this respect, the control unit 13 utilizes, for example, a relationship shown in FIG. 4, and sets the predetermined period TA based on the lateral distance D1 or the vehicle angle θ. According to FIG. 4, the longer the lateral distance D2 or the larger the vehicle angle θ, the shorter the predetermined period TA is set. Also, the predetermined period TA may be set to be variable based on the lateral distance D1 and the vehicle angle θ.

In FIG. 4, the lateral distance D1 may be defined as a distance from a lane marking opposite to the object lane marking of the lane departure avoidance to the vehicle CA. In this case, the shorter the lateral distance D1, the shorter the predetermined period TA may be set.

Alternatively, the control unit 13 acquires, as a state parameter, a traveling speed of the vehicle CA in a state of the steering angle of the vehicle CA being 0, and sets the predetermined period TA to be variable.

In a state where the steering angle of the vehicle CA is 0, the higher the traveling speed of the vehicle CA, the higher the probability of the vehicle CA excessively approaching the opposite side lane marking is, after the steering operation is changed to the manual steering operation from the automatic steering operation. In this respect, the control unit 13 utilizes, for example, a relationship shown in FIG. 5, and sets the predetermined period TA based on the traveling speed of the vehicle CA. According to FIG. 5, the higher the traveling speed of the vehicle CA, the shorter the predetermined period TA is set.

Further, the relationship shown in FIG. 4 and the relationship shown in FIG. 5 may be utilized to set the predetermined TA. In this case, the control unit 13 sets the predetermined period TA to be variable based on the vehicle angle θ and the vehicle speed.

In addition to the above-described configurations, lane width information related to a width of the traveling lane may be acquired (corresponding to information acquiring unit) and set the predetermined period TA to be variable. The lane width may be calculated based on the image captured by the camera 21 for example. Alternatively, the lane width may be acquired from map information.

In a state where the steering angle of the vehicle CA is 0, the smaller the lane width of the traveling lane, the higher the probability of the vehicle CA excessively approaching the opposite side lane marking is, after the steering operation is changed to the manual steering operation from the automatic steering operation. In this respect, the control unit 13 utilizes a relationship shown in FIG. 6 for example, and sets the predetermined period TA based on the lane width. According to FIG. 6, the smaller the lane width, the shorter the predetermined period TA is set. Also, the relationships shown in FIGS. 4-6 may be combined and may set the predetermined period TA.

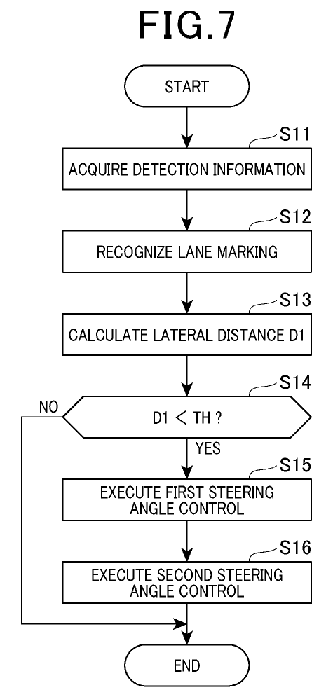

FIG. 7 illustrates a flowchart showing a procedure of a lane departure mitigation control. The present procedure is repeatedly executed by the ECU 10 at a predetermined period. Here, a traveling scene is assumed that the vehicle CA travels on a straight road.

In Fig,7, at step S11, the process acquires detection information from the camera 21, the radar apparatus 22, the speed sensor 23, the steering angle sensor 24 and the like. At step S12, the process recognizes left-right lane markings L1 and L2 on the traveling lane where the vehicle CA travels. At this moment, the process recognizes, based on the image captured by the camera 21, the lane markings L1 and L2 in the left and right sides of the traveling lane, and sets the respective lane markings L1 and L2 to be reference boundary lines in the left and right sides.

At step S13, the process calculates the lateral distance D1 between left and right end parts of the vehicle CA, and the lane markings L1 and L2. Next at step S14, the process determines whether the lateral distance D1 is less than the threshold TH. Then, when the lateral distance D1 is less than the threshold TH, the process proceeds to step S15. Thus, the lane departure mitigation control is activated with the lane markings L1 and L2 as the reference boundary lines.

At step S15, the process executes the first steering angle control for the lane departure avoidance. At this moment, with the steering control in the lane departure avoidance side, the orientation of the vehicle CA is changed to be along a direction away from the lane marking as an object of the lane departure avoidance, and with the current orientation, the steering angle of the vehicle CA is gradually changed to be 0.

At step S16, the process executes the second steering angle control. At this moment, the steering angle of the vehicle CA becomes 0 by the first steering angle control at step S15, thereafter, the state of the steering angle being 0 is maintained until a predetermined period TA elapses. In this case, a configuration for determining 0 steering angle based on the detection value of the steering angle sensor 24 may be utilized. Then, when the predetermined period TA elapses, the steering angle control is terminated. At step S16, the predetermined period TA may be set using relationships shown in FIGS. 4-6.

Thus far, a lane departure mitigation control is described assuming a travelling scene where the vehicle CA travels on the straight road. However, the lane departure mitigation control according to the present embodiment may be applied to a curved road other than the straight road. According to a traveling scene of the straight road, in the vehicle CA, the lateral acceleration with respect to the markings L1 and L2 and the steering angle are substantially the same. Hence, for example, as shown in FIG. 3, after activating the steering angle control, a timing at which the steering angle becomes 0 and a timing at which the lateral acceleration of the vehicle CA becomes 0 are substantially the same (timing t2).

In contrast, in the case of a traveling scene of the curved road, for example, the vehicle CA travels along the traveling road (own lane) in a normal situation, with this state, a steering angle for turning the vehicle CA is produced. However, the lateral acceleration with respect to the lane markings L1 and L2 is considered to be substantially 0. In other words, for the vehicle CA, the lateral acceleration with respect to the lane markings L1 and L2 does not correspond to the steering angle. Hence, the ECU 10 performs a first steering control after activating the lane departure mitigation control such that the steering angle of the vehicle CA is controlled corresponding to zero lateral acceleration of the vehicle CA with respect to the lane marking, instead of changing the steering angle to be 0. Then, in the subsequent second steering angle control, after maintaining a state of the steering angle, where the lateral acceleration with respect to the lane marking is 0, for a predetermined period, the steering angle control is terminated.

The ECU 10 calculates a separation distance between the vehicle CA and the lane marking (lateral distance D1) in a direction orthogonal to the lane marking and calculates a second order differential value of the calculated separation distance, thereby calculating a lateral acceleration of the vehicle CA with respect to the lane marking. Then, in the first steering control, after activating the lane departure mitigation control, a steering control is performed in a direction away from the lane marking to which the vehicle CA excessively approaches, and then the steering angle is controlled in a return side until the lateral acceleration of the vehicle CA with respect to the lane marking becomes 0.

In a traveling scene of the curved road, an appropriate period as a predetermined period TA where the second steering control is performed is different from that of the traveling scene on the straight road. Also, in a traveling scene of the curved road, an appropriate period as a predetermined period TA varies depending on whether the vehicle CA approaches an inner side of the curve or an outer side of the curve.

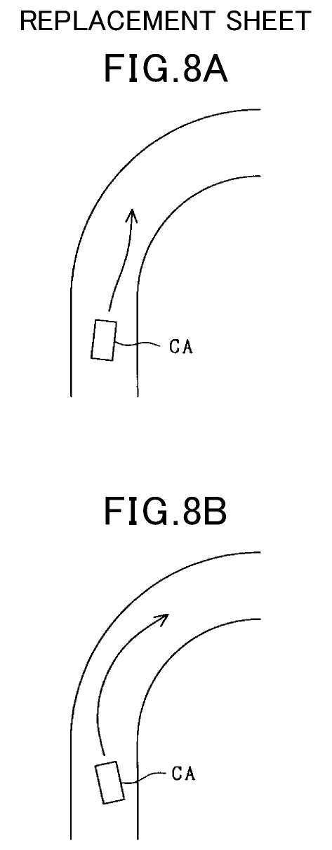

Specifically, as shown in FIG. 8A, in the case where the vehicle CA approaches a lane marking on an inner side of the curve in a traveling scene of a curved road, as a steering control of the lane departure mitigation control, a steering control of the vehicle CA is performed in a direction away from the lane marking of the inner side of the curved road. In this case, it is considered that the vehicle CA approaches, in a period shorter than that of a case where the traveling road is a straight road, a lane marking on an opposite side, that is, a lane marking on an outer side of the curve. Hence, the predetermined period TA may be set to be shorter than a period in the case where the vehicle travels on the straight road.

On the other hand, as shown in FIG. 8B, in the case where the vehicle CA approaches a lane marking on an outer side of the curve in a traveling scene of a curved road, as a steering control of the lane departure mitigation control, a steering control of the vehicle CA is performed in a direction away from the lane marking of the outer side of the curved road. In this case, it is considered that the vehicle CA approaches, in a period longer than that of a case where the traveling road is a straight road, a lane marking on an opposite side, that is, a lane marking on an inner side of the curve. Hence, the predetermined period TA may be set to be longer than a period in the case where the vehicle travels on the straight road.

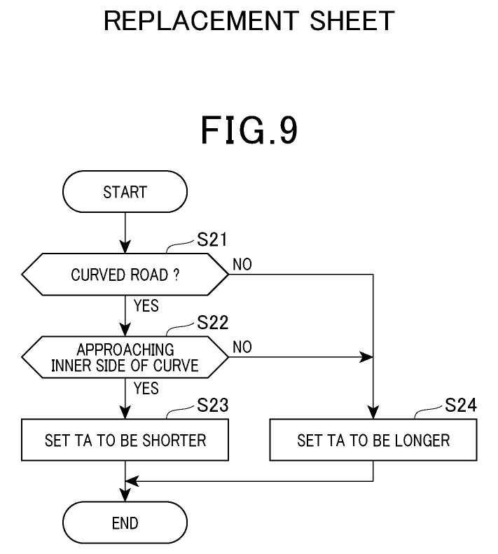

The ECU 10 may set the predetermined period TA using processes shown in FIG. 9. The present processes may be executed at step S16 after activating the lane departure mitigation process (after determining the process at step S14 to be YES).

In FIG. 9, at step S21, the process determines whether the vehicle CA is traveling on a curved road, and proceeds to step S22 when the determination at step S21 is YES. At step S22, the process determines whether the vehicle CA approaches a lane marking on an inner side of the curve (corresponds to state determination unit). Then, when the determination at step S22 is YES, that is, the vehicle CA approaches the lane marking on an inner side of the curve, the process sets the predetermined period TA to be shorter than that of a case where the steering angle control is activated during a traveling on the straight road. Moreover, when the determination at step S22 is NO, that is, the vehicle CA approaches a lane marking on an outer side of the curve, the process sets the predetermined period TA to be longer than that of a case where the steering angle control is activated during a traveling on the straight road.

According to the above-described present embodiments, the following effects and advantages can be obtained.

After activating the steering angle control, with the steering angle control in a lane departure avoidance side, the orientation of the vehicle CA is changed to be in a direction away from the lane marking as an object of the lane departure avoidance, and then the steering angle is controlled such that the lateral acceleration of the vehicle CA with respect to the lane marking becomes 0. Then, the steering control is terminated without performing reverse steering. Hence, a change in the orientation of the vehicle CA when the steering control is terminated can be suppressed, and it can be prevented from causing an incongruity sense of a driver of the vehicle CA. As a result, a control of a lane departure mitigation of the vehicle CA can be appropriately performed.

In the case where the vehicle CA travels on the straight road, when activating the steering control, with the steering angle control in a lane departure avoidance side, the orientation of the vehicle CA is changed to be in a direction away from the lane marking as an object of the lane departure avoidance. Then, the steering angle is controlled to be 0 and the steering angle control is terminated without performing the reverse steering. Even in this case, an appropriate lane departure mitigation control can be accomplished, considering a case where the lateral acceleration of the vehicle CA with respect to the lane marking becomes 0 with the steering angle being 0 when the vehicle CA travels straight.

Since the predetermined period TA is variably set based on the state parameter of the vehicle CA at a time when the steering angle of the vehicle CA becomes one corresponding to zero lateral acceleration of the vehicle CA, after controlling the steering angle, the automatic steering operation can be changed to a manual steering of the driver at an appropriate timing.

The predetermined period TA is variably set based on at least one of the lateral distance D1 and the vehicle angle θ. Thus, even when the positions of the vehicle CA in the traveling lane are different each time the traveling scene changes, after the steering angle control is performed, a change timing to the manual steering operation can be appropriate.

The predetermined period TA is variably set based on the traveling speed of the vehicle CA. Thus, even when the vehicle speed varies each time the traveling scene changes, after the steering angle control is performed, a change timing to the manual steering operation can be appropriate.

The predetermined period TA is variably set based on the lane width. Thus, even when the shape of the road are different each time the traveling scene changes, after the steering angle control is performed, a change timing to the manual steering operation can be appropriate.

When traveling on a curved road, the predetermined period TA is set based on whether the vehicle CA approaches a lane marking on an inner side of the curve or approaches a lane marking on an outer side of the curve. Thus, an appropriate lane departure mitigation control can be performed, considering a case where a time required for approaching an opposite side lane marking varies depending on whether the vehicle CA approaches a lane marking on an inner side of the curve or approaches a lane marking on an outer side of the curve.

### Modifications of the First Embodiment

The ECU 10 may execute at least one of a process for controlling the lateral distance D1 at a timing where the steering angle of the vehicle CA becomes a steering angle corresponding to zero lateral acceleration, to be a predetermined target lateral distance value and a process for controlling the vehicle angle θ at a timing where the steering angle of the vehicle CA becomes a steering angle corresponding to zero lateral acceleration, to be a predetermined target angle value. Further, the ECU 10 may variably set either the lateral distance target value or the target angle value. The ECU 10 sets at least one of the lateral distance target value or the target angle value, based on any one of the traveling speed of the vehicle CA when activating the steering angle control or after activating the steering angle control, lane width information of a traveling lane where the vehicle CA travels, curved road information and vehicle traveling line information on the curved road.

Note that the lateral distance target value is a target value of the lateral distance D1 from the lane marking as an object of the lane departure avoidance. The target angle value is a target value of a vehicle angle θ with respect to the lane marking as an object of the lane departure avoidance.

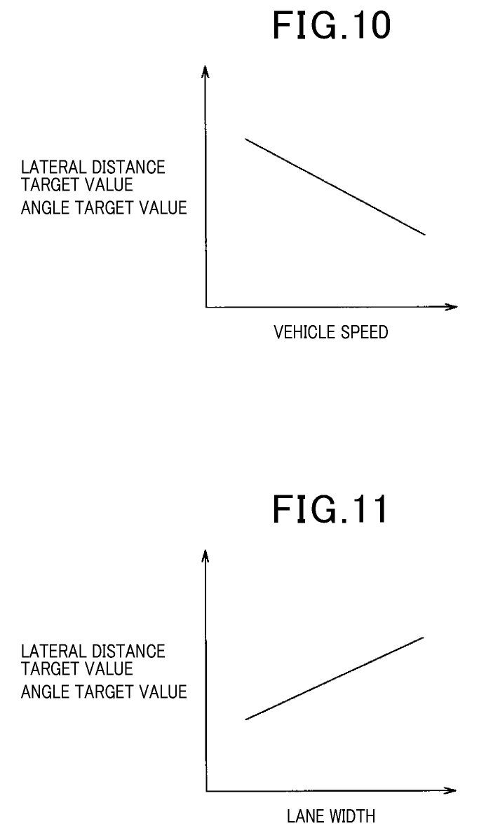

FIG. 10 is a diagram showing a relationship between the traveling speed of the vehicle CA when activating the steering angle control or after activating the steering angle control, and the lateral distance target value or the target angle value. A period after activating the steering angle control is for the first steering angle control. According to FIG. 10, the higher the traveling speed of the vehicle CA, the smaller the lateral distance target value is set. Alternatively, the higher the traveling speed of the vehicle CA, the smaller the target angle value is set.

FIG. 11 is a diagram showing a relationship between the lane width of the traveling lane and the lateral distance target value or the target angle value. According to FIG. 11, the smaller the lane width, the smaller the lateral distance target value is set. Alternatively, the smaller the lane width, the smaller the target angle value is set.

Further, in a traveling scene of the curved road, when the traveling line of the vehicle CA approaches inward the curve (see FIG. 8A), the ECU 10 sets the lateral distance target value and the target angle value to be smaller than those in a case where the traveling road is a straight road. Also, in a traveling scene of the curved road, when the traveling line of the vehicle CA approaches outward the curve (see FIG. 8B), the ECU 10 sets the lateral distance target value and the target angle value to be larger than those in a case where the traveling road is a straight road.

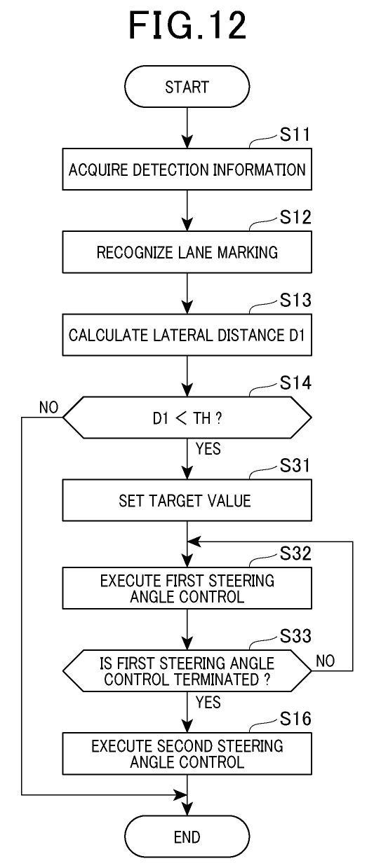

FIG. 12 is a flowchart showing a procedure of the lane departure mitigation control. The present procedure is repeatedly executed by the ECU 10 at a predetermined period. The present procedure is executed replacing a part of processes shown in FIG. 7. For the processes same as those in FIG. 7, the same step numbers are applied and the explanation thereof will be simplified.

In FIG. 12, at step S14, when the process determines that the lateral distance D1 is less than a threshold TH, the process proceeds to step S31. At step S31, the process sets at least one of the lateral distance target value and the target angle value at a time when terminating the first steering angle control. At this moment, at least one of the lateral distance target value and the target angle value is set based on any one of the traveling speed of the vehicle CA, the lane width information and the vehicle traveling line information.

Thereafter, at step S32, the process executes the first steering angle control for the lane departure avoidance. At this moment, the lateral distance D1 at a time when the steering angle of the vehicle CA becomes a steering angle corresponding to zero lateral acceleration is controlled to be a lateral distance target value, or the vehicle angle θ at a time when the steering angle of the vehicle CA becomes a steering angle corresponding to zero lateral acceleration is controlled to be a target angle value. Alternatively, the lateral distance D1 at a time when the steering angle of the vehicle CA becomes a steering angle corresponding to zero lateral acceleration is controlled to be a lateral distance target value, and the vehicle angle θ at a time when the steering angle of the vehicle CA becomes a steering angle corresponding to zero lateral acceleration is controlled to be a target angle value.

At step S33, the process determines whether to terminate the first steering angle control. Specifically, the process determines whether the steering angle of the vehicle CA is a steering angle corresponding to zero lateral acceleration. Here, the process may also determine whether the lateral distance D1 of the vehicle CA and the vehicle angle θ are the target values set at step S31. When determined that the first steering angle control is terminated, the process proceeds to step S16.

At step S16, the process executes a second steering angle control. At this moment, after the steering angle of the vehicle CA becomes 0 by the first steering angle control, the process maintains the state of the zero steering angle for the predetermined period TA. When the predetermined period TA elapses, the process terminates the steering angle control.

According to the above-described configurations, at least one of a process for controlling the lateral distance D1 to be a lateral distance target value at a timing where the steering angle of the vehicle CA becomes zero lateral acceleration and a process for controlling the vehicle angle θ to be a target angle value at a timing where the steering angle of the vehicle CA becomes zero lateral acceleration. Thus, the position and the orientation of the vehicle CA can be appropriately controlled at a timing where the steering angle of the vehicle CA becomes zero lateral acceleration.

Further, since at least one of a process for setting the lateral distance target value to be variable and a process for setting the target angle value to be variable is executed, even when each time the traveling scene changes, an appropriate steering control can be performed in the lane departure mitigation control.

### Second Embodiment

Hereinafter, for a second embodiment in which a part of configuration of the above-described first embodiment is modified, configurations different from those in the first embodiment will be described.

According to the present embodiment, the second steering angle control unit 15 is configured to selectively execute 2 steering angle control processes after executing the first steering angle control process. In 2 second steering angle control processes, one process is a first termination control that terminates, after the first steering angle control causes the steering angle of the vehicle CA to be a steering angle corresponding to zero lateral acceleration of the vehicle CA with respect to the lane marking, the steering angle control at a time when a predetermined period elapses maintaining the steering angle corresponding to the zero lateral acceleration. The first termination control corresponds to a control described as a second steering angle control in the first embodiment. The other process is a second termination control that causes, after the first steering angle control causes the steering angle of the vehicle CA to be a steering angle corresponding to zero lateral acceleration of the vehicle CA with respect to the lane marking, the orientation of the vehicle CA to be parallel to the lane marking by a reverse steering as a steering control in a reverse side of the first steering angle control, and then terminates the steering angle control. The second termination control corresponds to a steering angle control described with reference to FIG. 2.

The first termination control and the second termination control are selectively executed depending on a predetermined condition. The predetermined condition refers to a degree of reliability of recognizing a lane marking for example. Here, the second termination control is configured to perform a reverse steering such that a traveling direction of the vehicle CA is parallel to the lane marking. In this case, when the lane marking is difficult to be recognized due to deterioration or blur, stains and the like, that is, the reliability of recognizing the lane marking is low, the orientation of the vehicle CA may vary at a time when the steering angle control is terminated. In contrast, when the reliability of recognizing the lane marking is high, variation in the orientation of the vehicle CA at a time when the steering angle control is terminated may be lowered. For this reason, according to the present embodiment, the first termination control and the second termination control are selectively executed based on reliability of recognizing the lane marking.

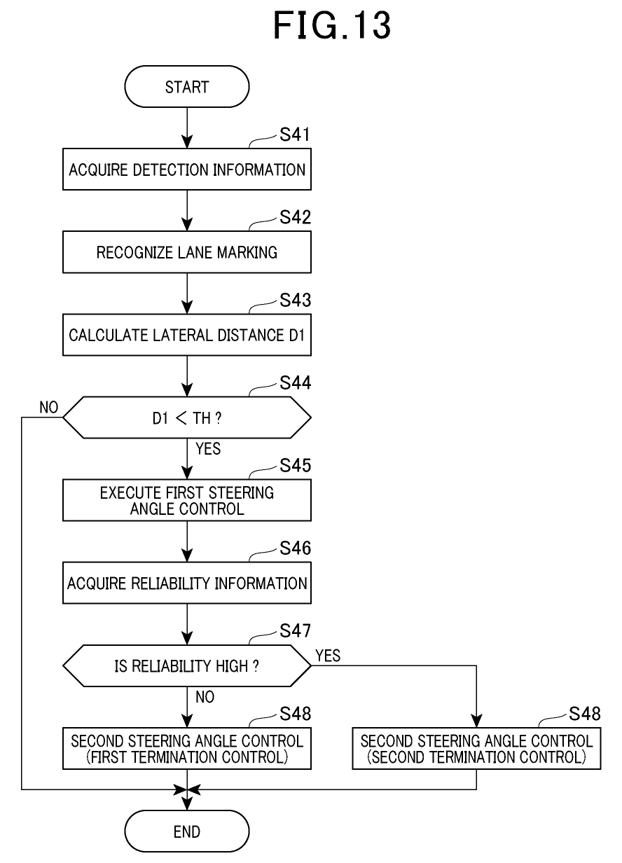

FIG. 13 is a flowchart showing a procedure of a lane departure mitigation control according to the second embodiment. The present procedure is repeatedly executed at a predetermined period.

In FIG. 13, since processes at steps S41 to S44 are the same as those in the steps S11 to S14, the respective processes are simply described here. At step S41, the process acquires detection information from the camera 21, the radar apparatus 22, the speed sensor 23 and the like. At step S42, the process recognizes left and right lane markings L1 and L2 on the traveling lane. At step S43, the process calculates the lateral distance D1 between left and right end parts of the vehicle CA, and the lane markings L1 and L2. At step S44, the process determines whether the lateral distance D1 is less than a threshold TH. Then, when the lateral distance D1 is less than the threshold TH, the process proceeds to step S45. Thus, a lane departure mitigation control is activated with the lane markings L1 and L2 as reference boundary lines.

At step S45, the process executes a first steering control for a lane departure avoidance. At this time, with a steering operation in a direction to avoid the deviation so as to change the orientation of the vehicle CA to be along a direction away from the lane marking from which the vehicle CA is deviating, and the steering angle of the vehicle CA is controlled with the current vehicle orientation such that the lateral acceleration of the vehicle CA with respect to the lane marking is 0.

At step S46, the process acquires reliability information indicating a reliability of a lane marking recognition. The reliability information refers to information indicating whether the reliability for recognizing the lane marking is high or low. The reliability for recognizing the lane marking may be determined based on a degree of edge intensity or a continuity of edge points when extracting the lane marking from the camera. In this case, when the reliability index calculated from the degree of edge intensity or the continuity of edge points is predetermined value or higher, the process determines that the reliability is high (reliability of the lane marking is higher than or equal to a predetermined degree), and when the reliability index is less than a predetermined value, the process determines that the reliability is low (reliability of the lane marking is less than a predetermined value).

At step S47, the process determines whether the reliability of the lane marking is high, that is, whether the reliability is higher than or equal to a predetermined degree. When determined that the reliability of the lane marking is low, the process proceeds to step S48 and executes the first termination control as a first steering control. Also, when determined that the reliability of the lane marking is high, the process proceeds to step S49 and executes the second termination control as a second steering control.

At step S48, after the steering angle of the vehicle CA is caused to be a steering angle corresponding to zero lateral acceleration in the first steering control at step S45, the process maintains the state of the steering angle until a predetermined period TA elapses. Then, after the predetermined period TA elapses, the steering control is terminated (first termination control).

At step S49, after the steering angle of the vehicle CA is caused to be a steering angle corresponding to zero lateral acceleration in the first steering control at step S45, the orientation of the vehicle CA is caused to be parallel to the lane marking by a reverse steering as a steering control in a reverse side of the first steering angle control, and then the process terminates the steering angle control (second termination control).

In the processes shown in FIG. 13, as described with reference to FIG. 12, also the first steering control with a lateral distance target value or an angle target value can be executed.

According to the configuration of the present embodiment, the first termination control that prioritizes a mitigation of an incongruity sense of a driver and the second termination control that prioritizes a formation of an orientation of the vehicle CA after performing the steering control can be selectively executed. Hence, an appropriate lane departure mitigation control can be executed considering a change in the traveling scene.

A configuration is employed in which a steering angle control is terminated after changing the orientation of the vehicle CA to be parallel to the lane marking with a reverse steering in a state where the reliability for recognizing the lane marking is higher than or equal to a predetermined degree (second termination control). Thus, in a state where the driver is unlikely to feel incongruity sense since the orientation of the vehicle CA is unlikely to vary after performing the steering angle control, the vehicle orientation can be appropriately formed to be along the traveling lane.

### Other Embodiments

The above-described embodiments may be modified in the following manners.

According to the above-described second embodiment, a predetermined condition as a reliability of the lane marking is used and either the first termination control or the second termination control is selectively executed as a second steering angle control (resume control) based on the reliability of the lane marking. However, this configuration may be modified. For example, a lane width as a width of the traveling lane may be determined as a predetermined condition, and the first termination control may be executed when the lane width is less than the predetermined value, the second termination control may be executed when the lane width is larger than or equal to the predetermined value. Also, with a predetermined condition as a user setting command, the first termination control or the second termination control may be selectively executed in accordance with the user setting command.

The control apparatus and method thereof disclosed in the present disclosure may be accomplished by a dedicated computer constituted of a processor and a memory programmed to execute one or more functions embodied by computer programs. Alternatively, the control apparatus and method thereof disclosed in the present disclosure may be accomplished by a dedicated computer provided by a processor configured of one or more dedicated hardware logic circuits. Further, the control apparatus and method thereof disclosed in the present disclosure may be accomplished by one or more dedicated computer where a processor and a memory programmed to execute one or more functions, and a processor configured of one or more hardware logic circuits are combined. Furthermore, the computer programs may be stored, as instruction codes executed by the computer, into a computer readable non-transitory tangible recording media.

Technical ideas extracted from the above-described embodiments will be described as follows.

### Configuration 1

A vehicle control apparatus configured to execute, for a vehicle traveling on a road, a steering angle control for controlling a steering angle of the vehicle to prevent the vehicle from deviating outside a reference boundary line, when the vehicle approaches the reference boundary line within a predetermined distance, the reference boundary line being either a road boundary as road ends of left and right sides of a road or left-right markings on a traveling lane in the road, the vehicle control apparatus comprising:
a first steering angle control unit that controls, when activating the steering angle control, a orientation of the vehicle to be oriented away from the reference boundary line in a lateral direction of the road using a steering operation for lane-departure avoidance side, and while maintaining the vehicle orientation, controls the steering angle of the vehicle to cause a lateral acceleration of the vehicle with respect to the reference boundary line to be 0; and
a second steering angle control unit that terminates, when the steering angle of the vehicle is controlled by the first steering control unit to be a steering angle causing the lateral acceleration tobe 0, the steering angle control at a time when a predetermined period elapses maintaining the controlled steering angle corresponding to the lateral acceleration of 0.

### Configuration 2

The vehicle control apparatus according to configuration 1,
wherein
   in the case where the vehicle travels on a straight road,
   the first steering angle control unit controls, as a control for causing the steering angle of the vehicle to be corresponding to zero lateral acceleration, the steering angle of the vehicle to be 0; and
   the second steering angle control unit terminates, after the first steering angle control unit controls the steering angle of the vehicle to be 0 as a 0-steering angle, the steering angle control at a time when a predetermined period elapses maintaining the 0-steering angle.

### Configuration 3

The vehicle control apparatus according to configuration 1 or 2,
wherein
   a parameter acquiring unit is provided to acquire a state parameter showing a traveling state of the vehicle at a time when the steering angle of the vehicle becomes a steering angle corresponding to zero lateral acceleration; and
   the second steering angle control unit sets the predetermined period to be variable based on the state parameter.

### Configuration 4

The vehicle control apparatus according to configuration 3,
wherein
   the parameter acquiring unit acquires, as the state parameter, at least one of a lateral distance from a lane marking of a traveling lane where the vehicle travels to the vehicle and a vehicle angle as an angle of a traveling direction of the vehicle inclined with respect to the lane marking; and
   the second steering angle control unit sets the predetermined period to be variable based on at least one of the acquired lateral distance or the acquired vehicle angle.

### Configuration 5

The vehicle control apparatus according to configuration 3 or 4,
wherein
   the parameter acquiring unit acquires a traveling speed of the vehicle as the state parameter; and
   the second steering angle control unit sets the predetermined period to be variable based on the traveling speed of the vehicle.

### Configuration 6

The vehicle control apparatus according to any one of configurations 1 to 5,
wherein
   information acquiring unit is provided to acquire lane width information related to a traveling lane where the vehicle travels; and
   the second steering angle control unit sets the predetermined period to be variable based on the lane width information.

### Configuration 7

The vehicle control apparatus according to any one of configurations 1 to 6,
wherein
   a state determination unit is provided to determine, when activating the steering angle control during a traveling on a curved road, whether the vehicle approaches the reference boundary line on an inner side of the curved road or whether the vehicle approaches the reference boundary line in an outer side of the curved road;
   the second steering angle control unit sets, when determining that the vehicle approaches the reference boundary line on an inner side of the curved road, the predetermined period to be shorter than that of a case where the steering angle control is activated when traveling on a straight road; and
   the second steering angle control unit sets, when determining that the vehicle approaches the reference boundary line in an outer side of the curved road, the predetermined period to be longer than that of a case where the steering angle control is activated when traveling on a straight road.

### Configuration 8

The vehicle control apparatus according to any one of configurations 1 to 7,
wherein
   the first steering angle control unit executes at least one of:
   a first control process in which a lateral distance from a lane marking of a traveling road where the vehicle travels to the vehicle at a time when the steering angle of the vehicle becomes a steering angle corresponding to zero lateral acceleration is controlled to be a lateral distance target value; and
   a second control process in which a vehicle angle as an angle of a traveling direction of the vehicle inclined with respect to a lane marking of a traveling road where the vehicle travels at a time when the steering angle of the vehicle becomes a steering angle corresponding to zero lateral acceleration is controlled to be a target angle value.

### Configuration 9

The vehicle control apparatus according to configuration 8,
wherein
   the first steering angle control unit sets at least one of the lateral distance target value and the target angle value to be variable, based on a traveling speed of the vehicle when activating or after activating the steering angle control, lane width information related to a width of a traveling lane where the vehicle travels, a curved road information and vehicle traveling line information on a curved road.

### Configuration 10

The vehicle control apparatus according to any one of configurations 1 to 9,
wherein
   a lane width recognition unit is provided to recognize left and right markings of a traveling lane where the vehicle travels;
   the second steering angle control unit is capable of executing a first termination control and a second termination control;
   the first termination control terminates, after the first steering angle control causes the steering angle of the vehicle to be a steering angle corresponding to the zero lateral acceleration,
   the steering angle control at a time when a predetermined period elapses maintaining the steering angle corresponding to the zero lateral acceleration;
   the second termination control causes, after the first steering angle control causes the steering angle of the vehicle to be a steering angle corresponding to the zero lateral acceleration, a orientation of the vehicle to be parallel to the lane marking by a reverse steering as a steering control in a reverse side of the first steering angle control, and then terminates the steering angle control; and
   the second steering angle control unit selectively executes the first termination control and the second termination control depending on a predetermined condition.

### Configuration 11

The vehicle control apparatus according to configuration 10,
wherein
   a reliability determination unit is provided to determine a reliability for recognizing the lane marking;
   the second steering angle control unit utilizes the reliability as the predetermined condition;
   when the reliability determined by the reliability determination unit is less than a predetermined value, the first termination control terminates the steering angle control at a time when a predetermined period elapses maintaining the steering angle corresponding to the zero lateral acceleration; and
   when the reliability determined by the reliability determination unit is higher than or equal to a predetermined value, the second termination control causes a orientation of the vehicle to be parallel to the lane marking by a reverse steering and then terminates the steering angle control.

### CONCLUSION

The present disclosure provides a vehicle control apparatus and program thereof capable of appropriately controlling a lane departure reduction of the vehicle.

The vehicle control apparatus according to the present disclosure executes, in the case where a vehicle travels on a road, a steering angle control for controlling a steering angle of the vehicle to prevent the vehicle from deviating outside a reference boundary line, when the vehicle approaches the reference boundary line within a predetermined distance, the reference boundary line being either a road boundary as road ends of left and right sides of a road or left-right markings on a traveling lane in the road, the vehicle control apparatus including: a first steering angle control unit that controls, when activating the steering angle control, a orientation of the vehicle to be oriented away from the reference boundary line in a lateral direction of the road using a steering operation for lane-departure avoidance side, and while maintaining the vehicle orientation, controls the steering angle of the vehicle to cause a lateral acceleration of the vehicle with respect to the reference boundary line to be 0; and a second steering angle control unit that terminates, when the steering angle of the vehicle is controlled by the first steering control unit to be a steering angle causing the lateral acceleration to be 0, the steering angle control at a time when a predetermined period elapses maintaining the controlled steering angle corresponding to the lateral acceleration of 0.

In the case where the vehicle deviates in one side of the road, that is, a left side or a right side and approaches a reference boundary line within a predetermined distance, the steering angle of the vehicle is controlled as a steering control to prevent the vehicle from deviating outside the reference boundary line. At this moment, in the case where the steering angle control is performed to cause the vehicle move away from the reference boundary line and then a reverse steering control is performed, and this may cause an incongruity sense of a driver. In this respect, according to the above-described configuration, when activating the steering angle control, a orientation of the vehicle to be oriented away from the reference boundary line with a steering control in a lane departure avoidance side, and while maintaining the vehicle orientation, the steering angle of the vehicle is controlled to cause a lateral acceleration of the vehicle with respect to the reference boundary line to be 0. Further, after the steering angle of the vehicle is controlled to be corresponding to zero lateral acceleration with respect to the reference boundary line, the steering angle control is terminated at a time when a predetermined period elapses maintaining the controlled steering angle. In this case, with a steering control in a lane

departure avoidance side, the vehicle orientation is oriented away from the reference boundary line as an object of the lane departure avoidance. Thereafter, the steering angle is controlled to be a predetermined angle with respect to the reference boundary line and the steering angle control is terminated. Hence, a change in the orientation of the vehicle when the steering control is terminated can be suppressed, and it can be prevented from causing an incongruity sense of a driver of the vehicle. As a result, a control of a lane departure mitigation of the vehicle can be appropriately performed.

What is claimed is:

1. A vehicle control apparatus configured to execute, for a vehicle traveling on a road, a steering angle control for controlling a steering angle of the vehicle to prevent the vehicle from deviating outside a reference boundary line, when the vehicle approaches the reference boundary line within a predetermined distance, the reference boundary line being either a road boundary as road ends of left and right sides of a road or left-right markings on a traveling lane in the road, the vehicle control apparatus comprising:
a first steering angle control unit that controls, when activating the steering angle control, a orientation of the vehicle to be oriented away from the reference boundary line in a lateral direction of the road using a steering operation for lane-departure avoidance side, and while maintaining the vehicle orientation, controls the steering angle of the vehicle to cause a lateral acceleration of the vehicle with respect to the reference boundary line to be 0; and
a second steering angle control unit that terminates, when the steering angle of the vehicle is controlled by the first steering control unit to be a steering angle causing the lateral acceleration to be 0, the steering angle control at a time when a predetermined period elapses maintaining the controlled steering angle corresponding to the lateral acceleration of 0.

2. The vehicle control apparatus according to claim 1,
wherein
in the case where the vehicle travels on a straight road,
the first steering angle control unit controls, as a control for causing the steering angle of the vehicle to be corresponding to zero lateral acceleration, the steering angle of the vehicle to be 0; and
the second steering angle control unit terminates, after the first steering angle control unit controls the steering angle of the vehicle to be 0 as a zero steering angle, the steering angle control at a time when a predetermined period elapses maintaining the zero steering angle.

3. The vehicle control apparatus according to claim 1,
wherein
a parameter acquiring unit is provided to acquire a state parameter showing a traveling state of the vehicle at a time when the steering angle of the vehicle becomes a steering angle corresponding to zero lateral acceleration; and
the second steering angle control unit sets the predetermined period to be variable based on the state parameter.

4. The vehicle control apparatus according to claim 3,
wherein
the parameter acquiring unit acquires, as the state parameter, at least one of a lateral distance from a lane marking of a traveling lane where the vehicle travels to the vehicle and a vehicle angle as an angle of a traveling direction of the vehicle inclined with respect to the lane marking; and
the second steering angle control unit sets the predetermined period to be variable based on at least one of the acquired lateral distance or the acquired vehicle angle.

5. The vehicle control apparatus according to claim 3,
wherein
the parameter acquiring unit acquires a traveling speed of the vehicle as the state parameter; and
the second steering angle control unit sets the predetermined period to be variable based on the traveling speed of the vehicle.

6. The vehicle control apparatus according to claim 1,
wherein
information acquiring unit is provided to acquire lane width information related to a traveling lane where the vehicle travels; and
the second steering angle control unit sets the predetermined period to be variable based on the lane width information.

7. The vehicle control apparatus according to claim 1,
wherein
a state determination unit is provided to determine, when activating the steering angle control during a traveling on a curved road, whether the vehicle approaches the reference boundary line on an inner side of the curved road or whether the vehicle approaches the reference boundary line in an outer side of the curved road;
the second steering angle control unit sets, when determining that the vehicle approaches the reference boundary line on an inner side of the curved road, the predetermined period to be shorter than that of a case where the steering angle control is activated when traveling on a straight road; and
the second steering angle control unit sets, when determining that the vehicle approaches the reference boundary line in an outer side of the curved road, the predetermined period to be longer than that of a case where the steering angle control is activated when traveling on a straight road.

8. The vehicle control apparatus according to claim 1,
wherein
the first steering angle control unit executes at least one of:
a first control process in which a lateral distance from a lane marking of a traveling road where the vehicle travels to the vehicle at a time when the steering angle of the vehicle becomes a steering angle corresponding to zero lateral acceleration is controlled to be a lateral distance target value; and
a second control process in which a vehicle angle as an angle of a traveling direction of the vehicle inclined with respect to a lane marking of a traveling road where the vehicle travels at a time when the steering angle of the vehicle becomes a steering angle corresponding to zero lateral acceleration is controlled to be a target angle value.

9. The vehicle control apparatus according to claim 8,
wherein
the first steering angle control unit sets at least one of the lateral distance target value and the target angle value to be variable, based on a traveling speed of the vehicle when activating or after activating the steering angle control, lane width information related to a width of a traveling lane where the vehicle travels, a curved road information and vehicle traveling line information on a curved road.

10. The vehicle control apparatus according to claim 1,
wherein
a lane width recognition unit is provided to recognize left and right markings of a traveling lane where the vehicle travels;
the second steering angle control unit is capable of executing a first termination control and a second termination control;
the first termination control terminates, after the first steering angle control causes the steering angle of the vehicle to be a steering angle corresponding to the zero lateral acceleration, the steering angle control at a time when a predetermined period elapses maintaining the steering angle corresponding to the zero lateral acceleration;
the second termination control causes, after the first steering angle control causes the steering angle of the vehicle to be a steering angle corresponding to the zero lateral acceleration, a orientation of the vehicle to be parallel to the lane marking by a reverse steering as a steering control in a reverse side of the first steering angle control, and then terminates the steering angle control; and
the second steering angle control unit selectively executes the first termination control and the second termination control depending on a predetermined condition.

11. The vehicle control apparatus according to claim 10,
wherein
a reliability determination unit is provided to determine a reliability for recognizing the lane marking;
the second steering angle control unit utilizes the reliability as the predetermined condition;
when the reliability determined by the reliability determination unit is less than a predetermined value, the first termination control terminates the steering angle control at a time when a predetermined period elapses maintaining the steering angle corresponding to the zero lateral acceleration; and
when the reliability determined by the reliability determination unit is higher than or equal to a predetermined value, the second termination control causes a orientation of the vehicle to be parallel to the lane marking by a reverse steering and then terminates the steering angle control.

12. A program stored in a non-transitory substantial recording media for executing, for a vehicle traveling on a road, a steering angle control for controlling a steering angle of the vehicle to prevent the vehicle from deviating outside a reference boundary line, when the vehicle approaches the reference boundary line within a predetermined distance, the reference boundary line being either a road boundary as road ends of left and right sides of a road or left-right markings on a traveling lane in the road, the program causes a processor to execute:
a first steering angle control process that controls, when activating the steering angle control, a orientation of the vehicle to be oriented away from the reference boundary line in a lateral direction of the road using a steering operation for lane-departure avoidance side, and while maintaining the vehicle orientation, controls the steering angle of the vehicle to cause a lateral acceleration of the vehicle with respect to the reference boundary line to be 0; and
a second steering angle control process that terminates, when the steering angle of the vehicle is controlled by the first steering control process to be a steering angle causing the lateral acceleration to be 0, the steering angle control at a time when a predetermined period elapses maintaining the controlled steering angle corresponding to the lateral acceleration of 0.
